(19) United States
(12) Patent Application Publication
(10) Pub. No.: US 2008/0209102 A1
(43) Pub. Date: Aug. 28, 2008

(54) Device, method, and computer product for monitoring cache-way downgrade

(75) Inventor: Tadashi Nakano, Fukuoka (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/000,915

(22) Filed: Dec. 18, 2007

(30) Foreign Application Priority Data
Feb. 26, 2007 (JP) 2007-046098

(51) Int. Cl. G06F 12/00

(52) U.S. Cl. 711/100; 711/E12.001

(57) ABSTRACT

A usage-rate measuring unit measures a CPU usage rate. A hit-count measuring unit measures a cache hit count indicating number of hits of a cache. A monitoring unit monitors the CPU usage rate and the cache hit count, and when a downgrade of the cache occurs, determines whether the CPU usage rate and the cache hit count are above a predetermined threshold.

### BACKGROUND OF THE INVENTION

1. Field of the Invention

The present invention generally relates to a technology for controlling and monitoring a downgrade of a cache way.

2. Description of the Related Art

A typical way-structured cache memory includes a plurality of parallel ways including blocks (unit of memory) corresponding to the number of indexes. A technology for controlling a downgrade of a cache memory (i.e., disabling a data storage area) has been developed.

Specifically, the number of correctable errors occurring in the cache memory is counted in units of way, and a way of the cache in which the number of errors exceeds a predetermined threshold is downgraded (i.e., a cache-way downgrade control is performed) (for example, see Japanese Patent Application Laid-open No. H2-302856). After a cache way is downgraded, a multiple processor system including the downgraded cache memory is stopped and a recovery operation for replacing a board is performed.

In the above technology, however, once a downgrade control is performed, the board is replaced even if a service is still available (for example, in the case where a CPU usage rate is low, but the board is not necessarily to be replaced), resulting in disabling the operation of the system.

### SUMMARY OF THE INVENTION

It is an object of the present invention to-at least partially solve the problems in the conventional technology.

A device according to one aspect of the present invention is for controlling a downgrade of a cache that is configured with a plurality of ways and for monitoring an error state of a downgrade-controlled cache. The device includes a usage-rate measuring unit that measures a usage rate of a central processing unit; a hit-count measuring unit that measures a cache hit count indicating number of hits of a cache; and a monitoring unit that monitors the usage rate of the central processing unit and the cache hit count, and when the downgrade of the cache occurs, determines whether the usage rate of the central processing unit and the cache hit count are above a predetermined threshold.

A method according to another aspect of the present invention is for controlling a downgrade of a cache that is configured with a plurality of ways and for monitoring an error state of a downgrade-controlled cache. The method includes measuring a usage rate of a central processing unit; measuring a cache hit count indicating number of hits of a cache; and monitoring including monitoring the usage rate of the central processing unit and the cache hit count, and determining, when the downgrade of the cache occurs, whether the usage rate of the central processing unit and the cache hit count are above a predetermined threshold.

A computer-readable recording medium according to still another aspect of the present invention stores therein a computer program for controlling a downgrade of a cache that is configured with a plurality of ways and for monitoring an error state of a downgrade-controlled cache. The computer program causes a computer to execute measuring a usage rate of a central processing unit; measuring a cache hit count indicating number of hits of a cache; and monitoring including monitoring the usage rate of the central processing unit and the cache hit count, and determining, when the downgrade of the cache occurs, whether the usage rate of the central processing unit and the cache hit count are above a predetermined threshold.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a cache-way downgrade monitoring device according to a first embodiment of the present invention;

FIG. 2 is a schematic diagram of a multiprocessor system according to the first embodiment;

FIG. 3 is a block diagram of the cache-way downgrade monitoring device shown in FIG. 1;

FIG. 4 is an example of a threshold information table;

FIG. 5 is a flowchart of a process performed by the cache-way downgrade monitoring device shown in FIG. 1;

FIG. 6 is a schematic diagram of a cache-way downgrade monitoring device according to a second embodiment of the present invention;

FIG. 7 is a flowchart of a process performed by the cache-way downgrade monitoring device shown in FIG. 6;

FIG. 8 is a schematic diagram of a cache-way downgrade monitoring device according to a third embodiment of the present invention; and

FIG. 9 is a schematic diagram of a cache-way downgrade monitoring device according to a fourth embodiment of the present invention.

### DETAILED DESCRIPTION OF THE PREFERRED EMBODIMENTS

Exemplary embodiments of the present invention are explained in detail below with reference to the accompanying drawings.

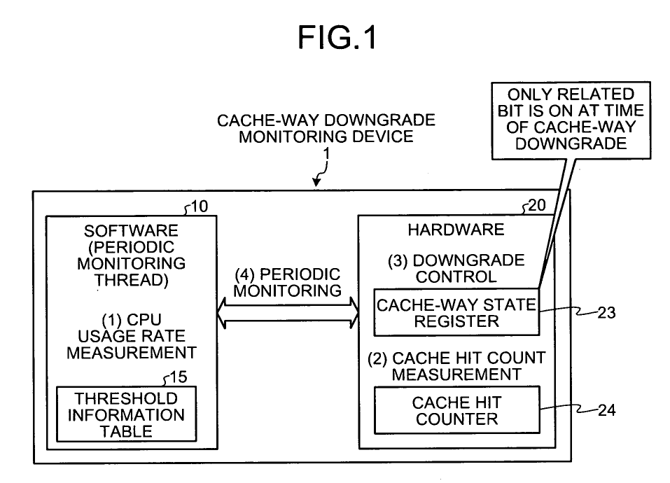

FIG. 1 is a schematic diagram of a cache-way downgrade monitoring device 1 according to a first embodiment of the present invention. The cache-way downgrade monitoring device 1 performs a downgrade control on a cache including a plurality of ways and monitors an error of the downgraded cache. The cache-way downgrade monitoring device 1 determines whether a system should continue the operation based on the state of the cache and a CPU.

Specifically, the cache-way downgrade monitoring device 1 includes a hardware 20 that performs a cache-way downgrade control and that measures the cache hit count, and a software (a periodic monitoring thread) 10 that controls the hardware 20 and that performs software processing.

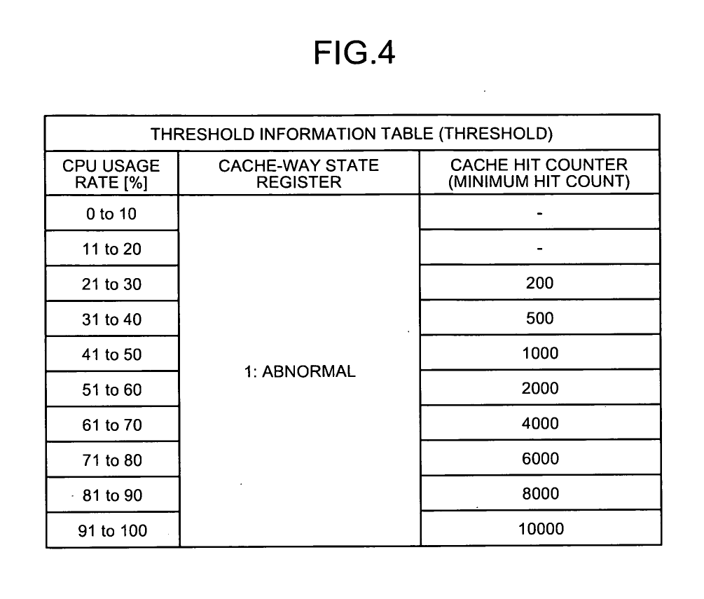

The software 10 includes a threshold information table 15 that stores a service limit (a predetermined threshold) determined by the cache-way downgrade (the threshold information table 15 is explained in detail below with reference to FIG. 4). The hardware 20 includes a cache-way state register 23 that stores information on the downgrade of the cache way (hereinafter, “cache-way downgrade”) obtained by the hardware 20, and a cache hit counter 24 that stores the cache hit count measured by the hardware 20.

The software 10 measures a CPU usage rate representing how much the software 10 uses the CPU (see, (1) shown in FIG. 1). Specifically, the software 10 determines whether a service processing of the software 10 is being performed, from a time of an idle thread.

The hardware 20 measures the cache hit count (see, (2) shown in FIG. 1). Specifically, the cache hit counter 24 is incremented when accessed data is stored in the cache.

When the cache-way downgrade occurs (see, (3) shown in FIG. 1), the software 10 monitors the CPU usage rate and the cache hit count measured by the hardware 20 and determines whether the CPU usage rate and the cache hit count are above the threshold (see, (4) shown in FIG. 1).

Specifically, when the cache-way downgrade occurs, a related bit of the cache-way state register 23 is ON. The software 10 periodically reads information on the bit (hereinafter, “bit information”) from the cache-way state register 23. When the bit is ON, the software 10 determines whether the CPU usage rate and the cache hit count are above the threshold stored in the threshold information table 15.

When it is determined that the CPU usage rate and the cache hit count are above the threshold, the software 10 records a cause of the cache-way downgrade in a storage unit (not shown) as history information and displays a message alerting replacement of a board (hereinafter, “board-replacement alerting message”) on an output unit (not shown).

As described above, even when the cache is downgraded, the operation of the system is not stopped if a load of the service is light, i.e., the CPU usage rate is low. The cache-way downgrade monitoring device 1 can determine whether the cache is available (i.e., whether the system processing requirement is satisfied) based on the state of the cache and the CPU, thereby properly determining whether the operation of the system should be continued.

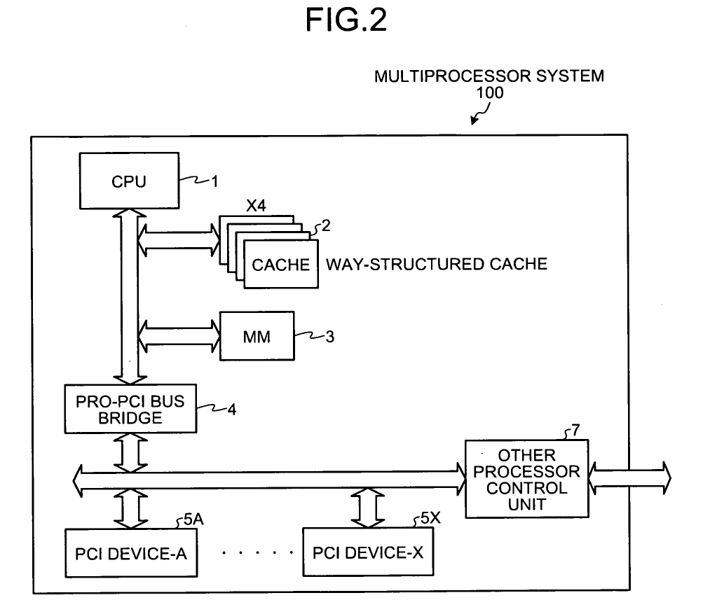

FIG. 2 is a schematic diagram of a multiprocessor system 100 to which the cache-way downgrade monitoring device 1 is applied. The multiprocessor system 100 includes a CPU (cache-way downgrade control device) 1, a cache 2 that includes a plurality of ways, a maim memory (MM) 3 that stores data and that is accessed by the CPU 1, a pro-PCI bus bridge 4 that converts data to be transmitted via a PCI bus, a plurality of devices including a PCI device-A 5a to a PCI device-X 5x, and an other processor control unit 7. The multiprocessor system 100 is connected to other processor via the other processor control unit 7.

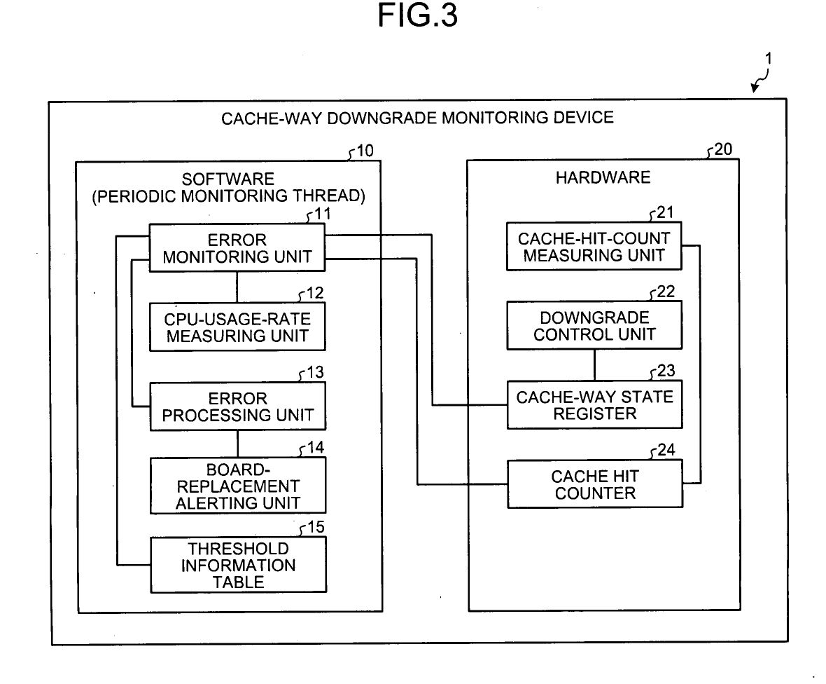

The configuration of the cache-way downgrade monitoring device 1 is explained below. FIG. 3 is a block diagram of the cache-way downgrade monitoring device 1. The cache-way downgrade monitoring device 1 includes the software 10 and the hardware 20. The software 10 includes an error monitoring unit 11, a CPU-usage-rate measuring unit 12, an error processing unit 13, a board-replacement alerting unit 14, and the threshold information table 15. The hardware 20 includes a cache-hit-count measuring unit 21, a downgrade control unit 22, the cache-way state register 23, and the cache hit counter 24. Processes performed by the above units are explained below.

FIG. 4 is an example of the threshold information table 15. The threshold information table 15 stores the service limit determined by the cache-way downgrade. Specifically, the threshold information table 15 stores the threshold of the CPU usage rate, the bit of the cache-way state register 23, and the threshold of the cache hit count stored in the cache hit counter 24 in combination. The threshold information is referred to when a process for determining an error (hereinafter, “error determining process”), which is described in detail below, is performed.

When the bit of the cache-way state register 23 is “1”, the software 10 determines whether to perform error processing by determining whether the cache hit count measured by the hardware 20 is larger than the cache hit count corresponding to the measured CPU usage rate. More specially, when the cache-way state register 23 is ON (i.e., the bit of the cache-way state register 23 is “1”) and the CPU usage rate is 75%, the error monitoring unit 11 determines that the cache is not sufficiently available if the cache hit counter 24 counts to 6,000 or more.

When the cache-way downgrade occurs, the error monitoring unit 11 determines whether the measured CPU usage rate and the cache hit count measured by the hardware 20 are above the threshold. Specifically, the error monitoring unit 11 reads the bit information from the cache-way state register 23. When the bit is “0” that represents normality, the error monitoring unit 11 continues periodically reading the bit information from the cache-way state register 23.

On the other hand, when the bit is “1” that represents abnormality, the error monitoring unit 11 reads the cache hit count from the cache hit counter 24. Subsequently, the error monitoring unit 11 issues an instruction for measuring the CPU usage rate to the CPU-usage-rate measuring unit 12, and the CPU-usage-rate measuring unit 12 measures the CPU usage rate. After receiving the CPU usage rate from the CPU-usage-rate measuring unit 12, the error monitoring unit 11 determines whether to perform the error processing with reference to the threshold information table 15, i.e., determines whether the cache hit count read from the cache hit counter 24 is above the threshold of the cache hit count corresponding to the measured CPU usage rate.

If the cache hit count is below the threshold, the error monitoring unit 11 periodically reads the cache hit count from the cache hit counter 24 and performs the error determining process. When the cache hit count exceeds the threshold, the error monitoring unit 11 issues an instruction for performing the error processing to the error processing unit 13.

The CPU-usage-rate measuring unit 12 measures the CPU usage rate. Specifically, after receiving the instruction for measuring the CPU usage rate from the error monitoring unit 11, the CPU-usage-rate measuring unit 12 measures the CPU usage rate based on the operation time of the idle thread, and notifies the error monitoring unit 11 of the CPU usage rate.

After receiving the instruction for performing the error processing from the error-monitoring unit 11, the error processing unit 13 records the cause of the downgrade in a storage unit as history information, and issues an instruction for alerting the replacement of the board (hereinafter, “board-replacement instruction”) to the board-replacement alerting unit 14.

After receiving the board-replacement instruction when the cache is unavailable (i.e., when the system performance requirements are not satisfied), the board-replacement alerting unit 14 displays the board-replacement alerting message on the output unit.

The cache-way state register 23 stores the information on the cache-way downgrade obtained by the hardware 20. Specifically, the cache-way state register 23 sets the bit ON and stores the bit when the cache-way downgrade occurs.

The cache hit counter 24 stores the cache hit count measured by the hardware 20. Specifically, the cache hit counter 24 is incremented when accessed data is in the cache. When the cache-way downgrade occurs, the error monitoring unit 11 reads the cache hit count from the cache hit counter 24.

The cache-hit-count measuring unit 21 measures the cash hit count. Specifically, the cache-hit-count measuring unit 21 increments the cache hit counter 24 when accessed data is in the cache.

The downgrade control unit 22 controls the cache-way downgrade when an error occurs in the cache. Specifically, the downgrade control unit 22 sets ON a related bit of the cache-way state register 23 when the cache-way downgrade occurs.

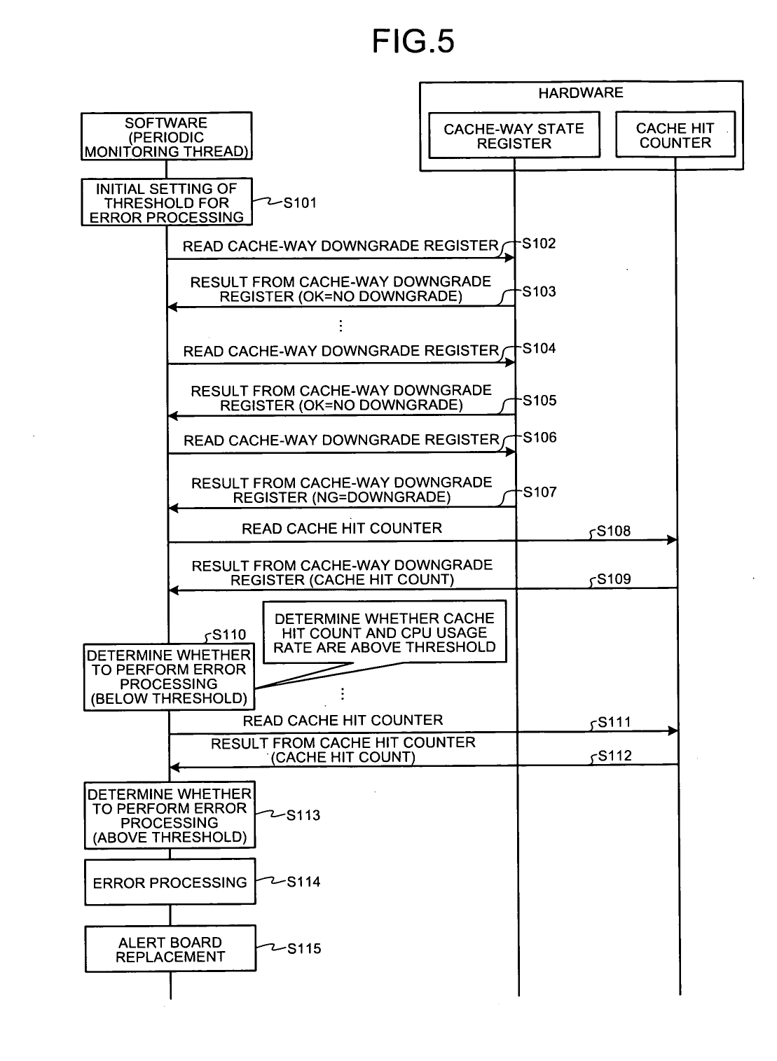

FIG. 5 is a flowchart of a process performed by the cache-way downgrade monitoring device 1. The software 10 performs an initial setting to the threshold in the threshold information table 15 that is referred when determination is made on whether to perform the error processing (step S101). The software 10 reads the bit information from the cache-way state register 23 (step S102). When the bit is “0”, which represents the normality (S103), the software 10 continues periodically reading the bit information from the cache-way state register 23 (step S104 and step S105).

When the software 10 reads the bit information from the cache-way state register 23 (step S106) and the bit is “1” that represents the abnormality (step S107), the software 10 reads the cache hit count from the cache hit counter 24 (step S108 and step S109). Thereafter, the software 10 receives the measured CPU usage rate, and performs the error determining process with reference to the threshold information table 15 (step S110).

If the cache hit count is below the threshold (step S110), the software 10 continues periodically reads the cache hit count from the cache hit counter 24 and repeatedly performs the error determination process (step Sill and step S112). When the cache hit count is above the threshold (step S113), the software 10 records the cause of the cache-way downgrade as history information in the storage unit (step S114), and issues the board-replacement instruction to the board-replacement alerting unit 14 (step S115).

According to the first embodiment, the CPU usage rate is measured and the cache hit count is measured. When the cache-way downgrade occurs, the software 10 determines whether the measured CPU usage rate and the cache hit count are above the threshold. Thus, even when the cache is downgraded, the system does not stop the operation as long as the service load is low (i.e., the CPU usage rate is low). In this manner, the software 10 can properly determine that the cache is unavailable (the system processing requirements are not satisfied) based on the state of the cache and the CPU, thereby determining whether to continue the operation of the system.

According to the first embodiment, the software performs the error determination process. Alternatively, the hardware can perform the error determination process and the software receives the result of the determination as in the case of a second embodiment of the present invention.

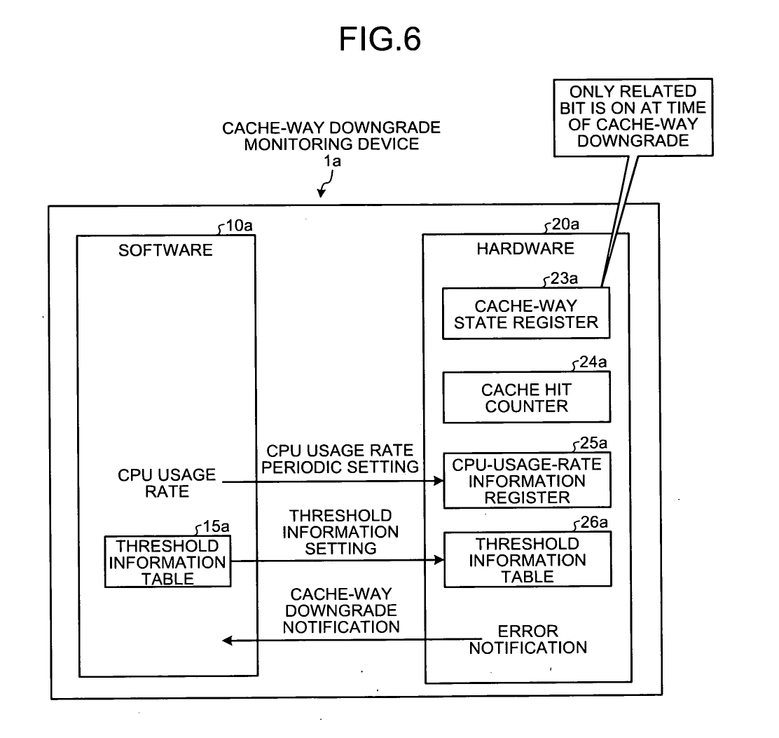

FIG. 6 is a schematic diagram of a cache-way downgrade monitoring device la according to the second embodiment. The cache-way downgrade monitoring device 1a includes a software 10a and a hardware 20a that includes a cache-way state register 23a and a cache hit counter 24a. The hardware 20a further includes a CPU-usage-rate information register 25a that stores a CPU usage rate, and a threshold information table 26a that stores a service limit (a predetermined threshold). The service limit is set by the software 10a and is determined by the cache-way downgrade.

The software 10a periodically sets a measured CPU usage rate in the CPU-usage-rate information register 25a. The hardware 20a periodically monitors the measured CPU usage rate stored in the CPU-usage-rate information register 25a and a cache hit count stored in the cache hit counter 24a, and determines whether the CPU usage rate and the cache hit count are above the threshold stored in the threshold information table 26a.

When the CPU usage rate and the cache hit count exceed the threshold, the hardware 20a issues a cache-way downgrade notification for instructing performing of error processing to the software 10a. After receiving the cache-way downgrade notification, the software 10a records a cause of the cache-way downgrade as history information in a storage unit (not shown), and displays the board-replacement alerting message on an output unit (not shown).

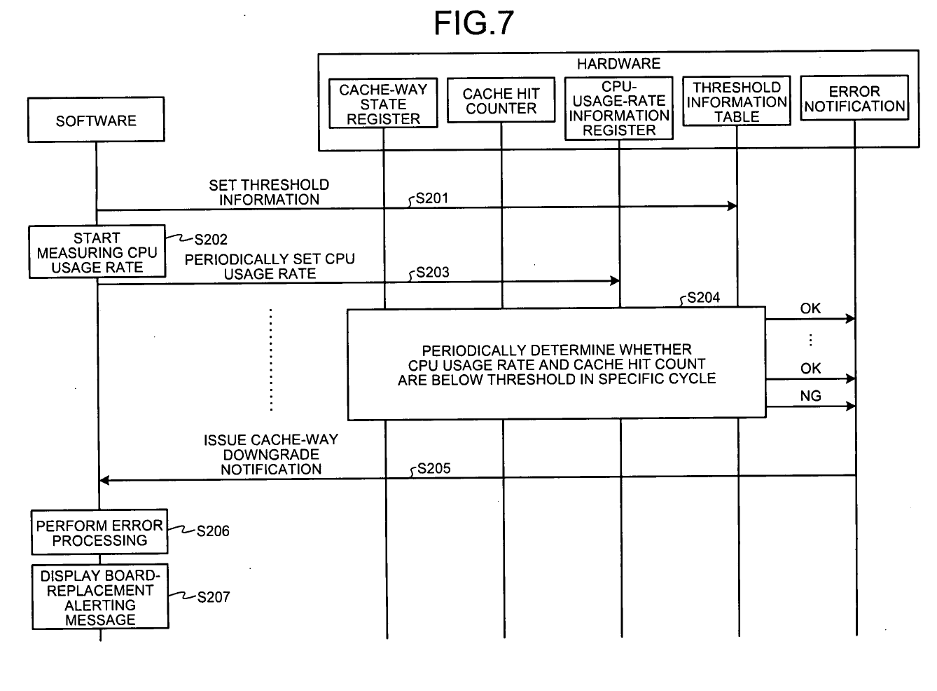

FIG. 7 is a flowchart of a process performed by the cache-way downgrade monitoring device 1a. According to the second embodiment the hardware 20a determines whether to continue the operation of the system.

Specifically, the software 10a sets threshold information in the threshold information table 26a (step S201). Thereafter, the software 10a starts measuring the CPU usage rate (step S202) and periodically sets the measured CPU usage rate to the CPU-usage-rate information register 25a (step S203).

Meanwhile, the hardware 20a periodically determines whether the CPU usage rate stored in the CPU-usage-rate information register 25a and the cache hit count stored in the cache hit counter 24a are above the threshold stored in the threshold information table 26a (step S204). When the CPU usage rate and the cache hit count are above the threshold, the hardware 20a issues the cache-way downgrade notification to the software 10a (step S205).

After receiving the cache-way downgrade notification, the software 10a records the cause of the cache-way downgrade as history information in the storage unit (step S206) and the displays the board-replacement alerting message on the output unit (step S207).

According to the second embodiment, the measured CPU usage rate is stored in the CPU-usage-rate information register 25a of the hardware 20a, and the measured cache hit count is stored-in the cache hit counter 24a of the hardware 20a. The hardware 20a determines whether the CPU usage rate stored in the CPU-usage-rate information register 25a and the cache hit count stored in the cache hit counter 24a are above the threshold, thereby independently determining whether to continue the operation of the system.

According to the first embodiment, the software reads the cache hit count from the hardware in a predetermined period. The present invention is not limited to this. The software can adjust the timing of reading the cache hit count as in the case of a third embodiment of the present invention.

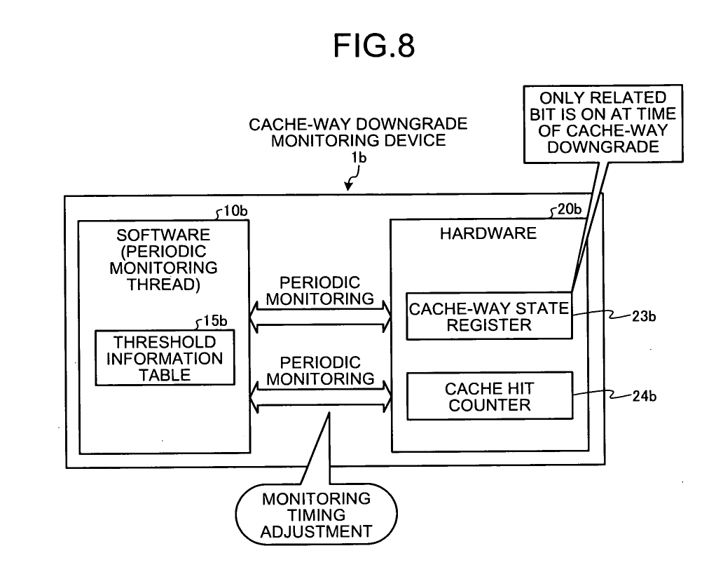

FIG. 8 is a schematic diagram of a cache-way downgrade monitoring device 1b according to the third embodiment. The cache-way downgrade monitoring device 1b monitors a CPU usage rate and a cache hit count, and determines whether the CPU usage rate and the cache hit count are above a predetermined threshold stored in the threshold information table 15b. When the CPU usage rate and the cache hit count are close to the threshold, a software 10b changes the monitoring period in a stepwise manner.

For example, when the CPU usage rate and the cache hit count are close to the threshold, the cache-way downgrade monitoring device 1b shorten the monitoring period to promptly detect an error before the service cannot be sufficiently available.

According to the third embodiment, when the CPU usage rate and the cache hit count are close to the threshold, the software 10b changes the monitoring period in a stepwise manner. In the changed monitoring periods, the software 10b determines whether the CPU usage rate and the cache hit count are above the threshold. For example, when the cache-way downgrade occurs frequently, the monitoring period is shortened. Accordingly, the software 10b can promptly detect an error before the system service is not sufficiently available.

According to the third embodiment, the software adjusts the timing of reading the cache hit count. Alternatively, the hardware can adjust the timing as in the case of a fourth embodiment of the present invention.

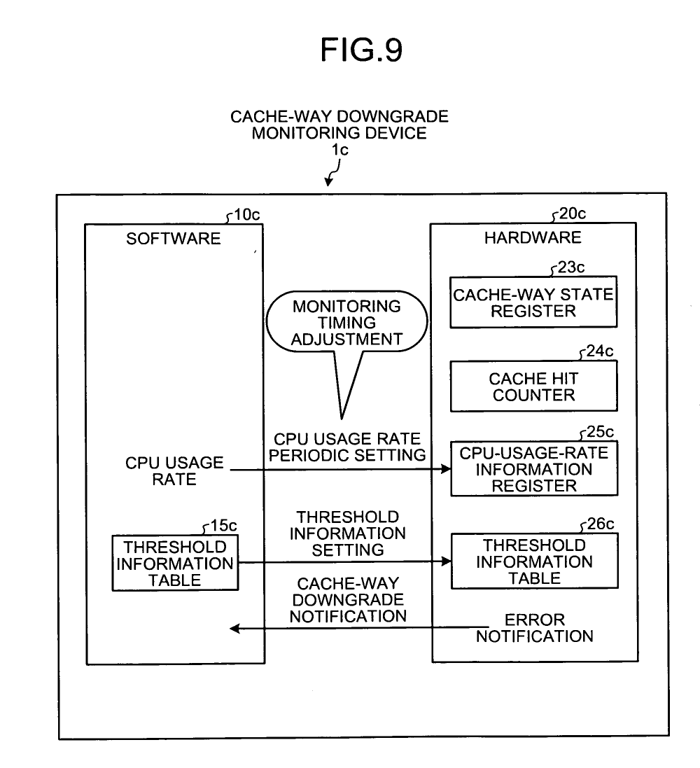

FIG. 9 is a schematic diagram of a cache-way downgrade monitoring device 1c according to the fourth embodiment. A hardware 20c of the cache-way downgrade monitoring device 1c sends information on a monitoring timing to a software 10c, and the software 10c controls a period in which the software 10c sets a CPU usage rate in the CPU-usage-rate information register 25c.

When the CPU usage rate and a cache hit count are close to a predetermined threshold, the hardware 20c changes the monitoring period in a stepwise manner. In the changed monitoring periods, the software 10c monitors the CPU usage rate and the cache hit count and determines whether the CPU usage rate and the cache hit count are above the threshold. For example, when the cache-way downgrade occurs frequently, the monitoring period is shortened. Accordingly, the software 10c can quickly detect an error before the system service is not sufficiently available.

The structural components (units) according to the first to fourth embodiments are schematic components, and thus, are not necessarily physically configured as shown in the accompanying drawings. In other words, the distribution and integration of each structural component is not limited to those shown in the drawings, and all of the units or a part of the structural components can be functionally or physically distributed or integrated in an arbitrary unit depending on various kinds of load or state. For example, the error monitoring unit 11 and the error processing unit 13 can be integrated. In addition, all of or a part of the processing functions performed by the structural components can be realized by the CPU and a program executed by the CPU or can be realized as hardware by a wired logic.

Moreover, all of or a part of the processes that are automatically performed according to the first to the fourth embodiments can be manually performed, and all of or a part of the processes that are manually performed according to the first to the fourth embodiments can be automatically performed. In addition, the processing or control order, names, information containing various data and parameters can be arbitrarily changed as long as those are not specified. For example, the threshold stored in the threshold information table can be arbitrarily changed.

A method of monitoring the cache-way downgrade according to the first to the fourth embodiments can be realized by a program executed by a computer such as a personal computer (PC) and a workstation. The program can be distributed via a network such as the Internet. In addition, the program can be stored in a computer-readable recording medium, such as a hard disk, a flexible disk (FD), a compact disc read only memory (CD-ROM), a magneto optical (MO) disk, and a digital versatile disk (DVD), and can be read from the recording medium by the computer.

According to an aspect of the present invention, a CPU usage rate and a cache hit count are measured. When a cache-way downgrade occurs, determination is made on whether a measured CPU usage rate and a measured cache hit count are above a predetermined threshold. Thus, even when a cache is downgraded, a system does not stop an operation as long as the CPU usage rate is low. In this manner, it can be properly determined that the cache is disabled (cache is not sufficiently available) based on the state of the cache and the CPU, thereby properly determining whether to continue the operation of the system.

Furthermore, according to another aspect of the present invention, a measured CPU usage rate is stored in a CPU-usage-rate storage unit of a hardware, and a measured cache hit count is stored in a cache-hit storage unit of the hardware. Determination is made on whether the CPU usage rate and the cache hit count stored in the hardware are above the threshold. In this manner, the hardware can independently determine whether to continue an operation of a system.

Moreover, according to still another aspect of the present invention, when a CPU usage rate and a cache hit count are close to a predetermined threshold, a software changes a monitoring period in a stepwise manner. In the changed monitoring periods, the software determines whether the CPU usage rate and the cache hit count are above the threshold. For example, when a cache-way downgrade occurs frequently, the monitoring period is shortened. Accordingly, the software can promptly detect an error before the system service is not sufficiently available.

Furthermore, according to still another aspect of the present invention, when a CPU usage rate and a cache hit count are close to a predetermined threshold, a hardware changes a monitoring period in a stepwise manner. In the changed monitoring periods, the hardware determines whether the CPU usage rate and the cache hit count are above the threshold. For example, when the cache-way downgrade occurs frequently, the monitoring period is shortened. Accordingly, the hardware can promptly detect an error before the system service is not sufficiently available.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A device for controlling a downgrade of a cache that is configured with a plurality of ways and for monitoring an error state of a downgrade-controlled cache, the device comprising:
a usage-rate measuring unit that measures a usage rate of a central processing unit;
a hit-count measuring unit that measures a cache hit count indicating number of hits of a cache; and
a monitoring unit that monitors the usage rate of the central processing unit and the cache hit count, and when the downgrade of the cache occurs, determines whether the usage rate of the central processing unit and the cache hit count are above a predetermined threshold.

2. The device according to claim 1, further comprising:
a usage-rate storing unit that stores the usage rate of the central processing unit measured by the usage-rate measuring unit in a first storage unit in a hardware,
a cache-hit storing unit that stores the cache hit count measured by the hit-count measuring unit in a second storage unit in the hardware, wherein
the monitoring unit determines whether the usage rate of the central processing unit stored in the first storage unit and the cache hit count stored in the second storage unit are above the predetermined threshold.

3. The device according to claim 1, further comprising a period changing unit that changes a monitoring period of the monitoring unit by a software in a stepwise manner when the usage rate of the central processing unit and the cache hit count are close to the predetermined threshold, wherein the monitoring unit determines whether the usage rate of the central processing unit and the cache hit count are above the predetermined threshold based on the monitoring period changed by the period changing unit.

4. The device according to claim 1, further comprising a period changing unit that changes a monitoring period of the monitoring unit by a hardware in a stepwise manner when the usage rate of the central processing unit and the cache hit count are close to the predetermined threshold, wherein the monitoring unit determines whether the usage rate of the central processing unit and the cache hit count are above the predetermined threshold based on the monitoring period changed by the period changing unit.

5. A method of controlling a downgrade of a cache that is configured with a plurality of ways and monitoring an error state of a downgrade-controlled cache, the method comprising:
measuring a usage rate of a central processing unit;
measuring a cache hit count indicating number of hits of a cache; and
monitoring including
monitoring the usage rate of the central processing unit and the cache hit count, and
determining, when the downgrade of the cache occurs, whether the usage rate of the central processing unit and the cache hit count are above a predetermined threshold.

6. A computer-readable recording medium that stores therein a computer program for controlling a downgrade of a cache that is configured with a plurality of ways and for monitoring an error state of a downgrade-controlled cache, the computer program causing a computer to execute:
measuring a usage rate of a central processing unit;
measuring a cache hit count indicating number of hits of a cache; and
monitoring including
monitoring the usage rate of the central processing unit and the cache hit count, and
determining, when the downgrade of the cache occurs, whether the usage rate of the central processing unit and the cache hit count are above a predetermined threshold.
